(19) United States
(12) Patent Application Publication
(10) Pub. No.: US 2005/0072805 A1
(43) Pub. Date: Apr. 7, 2005

(54) Foam dispenser with rigid container

(76) Inventor: Shaun Kerry Matthews, Oswestry (GB)

Correspondence Address: Ralph A. Dowell of DOWELL & DOWELL P.C., 2111 Eisenhower Ave., Suite 406, Alexandria, VA, 22314, US

(21) Appl. No.: 10/644,058

(22) Filed: Aug. 20, 2003

(51) Int. Cl. B67D 5/58

(52) U.S. Cl. 222/190

(57) ABSTRACT

The present invention is directed to a dispenser for dispensing foam employing a rigid container. The dispenser includes a rigid container, a pump, a method of venting air into the container and a housing. The rigid container has an interior wherein soap is received therein. The pump is attached to the bottom of the rigid container and is adapted to mix the soap with air and produce a foam. The container is either provided with an aperture so that air may be vented into the container or a snorkel is attached to the pump and extends between the pump and the top of the container such that air is vented into the container. The rigid container, the pump and the venting means are insertable into the housing and a lever in the housing operably engages the pump.

### FIELD OF THE INVENTION

This invention relates to dispensers for dispensing foam and in particular dispensers having a rigid container.

### BACKGROUND OF THE INVENTION

Dispensers for dispensing foam have been gaining popularity over the last five years. Large and small institutions have realized that there is significant cost savings in providing dispensers for dispensing foam rather than dispensers that dispense merely soap. The amount of soap that is used per hand wash is reduced considerably. Therefore for institutions with a large volume of traffic there can be significant savings. The foam has a number of other additional benefits. The foam tends to have a more luxurious feel than non foam soap thus promoting greater pleasure and thus more regular use. Further the foam has better wetting properties and thus in use the foam provides a more efficient hand wash that non foam soap.

Generally the current dispensers in regular use for dispensing foam are of two types. The first uses a rigid container in conjunction with a top mounted, vented dispensing pump an example of which is shown in U.S. Pat. Nos. 5,271,530 and 6,443,569 both issued to Uehira et al. and both of which are incorporated herein by reference in their entirety. These are usually used as free standing, portable dispensers. The second uses an inverted pump in association with a collapsible container that is housed in a dispenser, an example of which is shown in U.S. Pat. Nos. 5,445,288 and 6,082,586 issued to Banks and both of which are incorporated herein by reference in their entirety. This system is more conducive to use in secure wall mounted dispensers that typically have their actuators and soap exits at the bottom. Collapsible containers are used because the vent necessary to prevent the generation of a vacuum in the first type would leak foaming liquid if used in the inverted position. There are however a number of disadvantages to a collapsible container. Specifically collapsible containers are relatively more difficult to manufacture and to use.

In contrast there are a number of advantages that may be achieved by using a rigid container. Rigid containers can be manufactured from a much wider range of materials and thus the manufacturer may pick that material which best suits their needs. Materials with extended chemical resistance and improved permeation resistance may be used. In general rigid containers are easier to handle both empty and filed. Generally the rigid containers are made with more reliable manufacturing processes and are less likely to leak. As well rigid containers are easier to integrate into a filling line. In use a rigid container will generally be easier to use because it will be easier to empty the container of soap. Further it would be easier to see the level of soap and therefore using a rigid container will reduce the likelihood of prematurely changing the container while there is still soap therein.

A novel approach to combine rigid containers with an inverted foam generating pump is shown in Application CA 2341659 (Ophardt & Mlrbach). However this system uses a system of weirs and airlocks to prevent leakage.—Although this system is proven to be acceptable during periods of frequent use and stable ambient temperature and barometric pressure, if these conditions are not fulfilled, any small increase in relative internal pressure in the rigid container forces liquid soap out of the exit—resulting in wastage and a perception of leakage which is unacceptable to the customer.

Accordingly it would be advantageous to provide a soap dispenser for dispensing foam that uses a rigid container in association with an inverted pump and exit and a dispenser which is capable of withstanding normal fluctuations in Ambient temperature and pressure without leakage.

### SUMMARY OF THE INVENTION

The present invention is directed to a dispenser for dispensing foam employing a rigid container. The dispenser includes a rigid container, a pump, a method of venting air into the container and a housing. The rigid container has an interior wherein soap is received therein. The pump is attached to the bottom of the rigid container and is adapted to mix the soap with air and produce a foam. The container is either provided with an aperture so that air may be vented into the container or a snorkel is attached to the pump and extends between the pump and the top of the container such that air is vented into the container. The rigid container, the pump and the venting means are insertable into the housing and a lever in the housing operably engages the pump.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of the foam dispenser constructed in accordance with the present invention;

FIG. 2 is a perspective view of the rigid container of the dispenser of the present invention;

FIG. 3 is a cross-sectional view of the dispenser of present invention showing the rigid container in phantom;

FIG. 4 is an enlarged cross sectional view of telescoping pump attached to the rigid container;

FIG. 5 is an enlarged cross-sectional view of the inverted upright pump attached to the rigid container and having a snorkel attached to the pump; and

FIG. 6 is an enlarged cross-section view of the inverted upright pump attached to the rigid container and showing an aperture in the top of the rigid container.

### DETAILED DESCRIPTION OF THE INVENTION

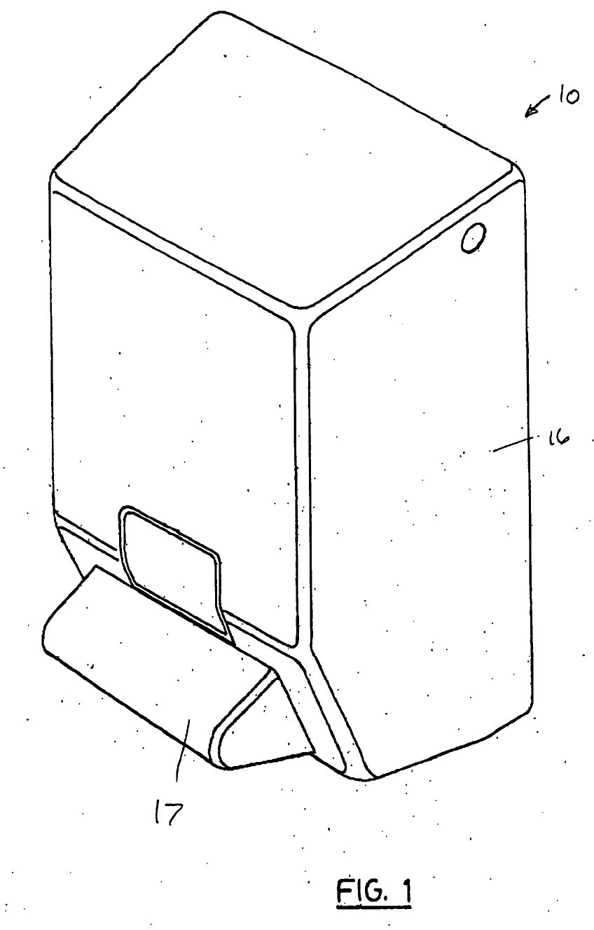

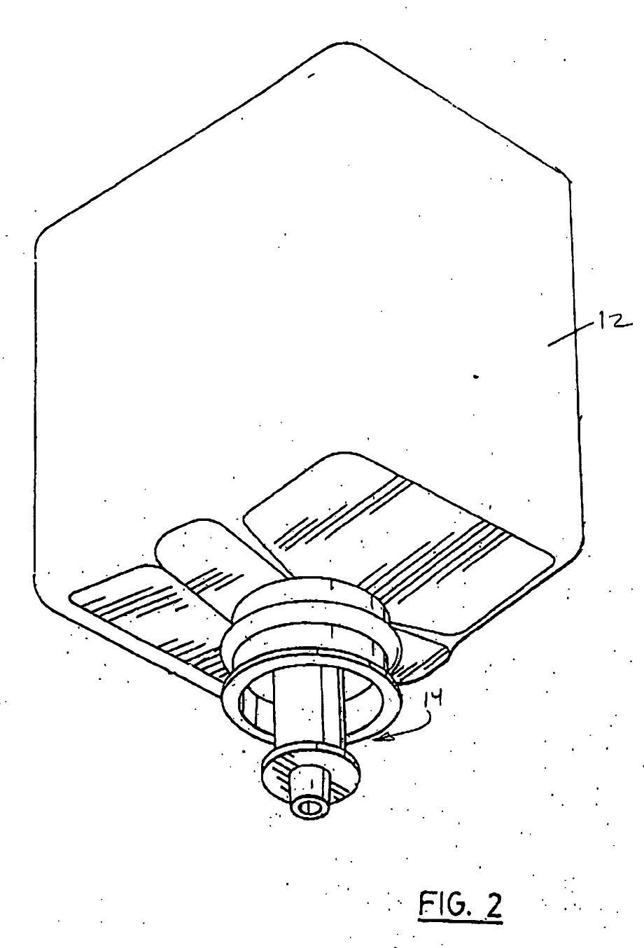

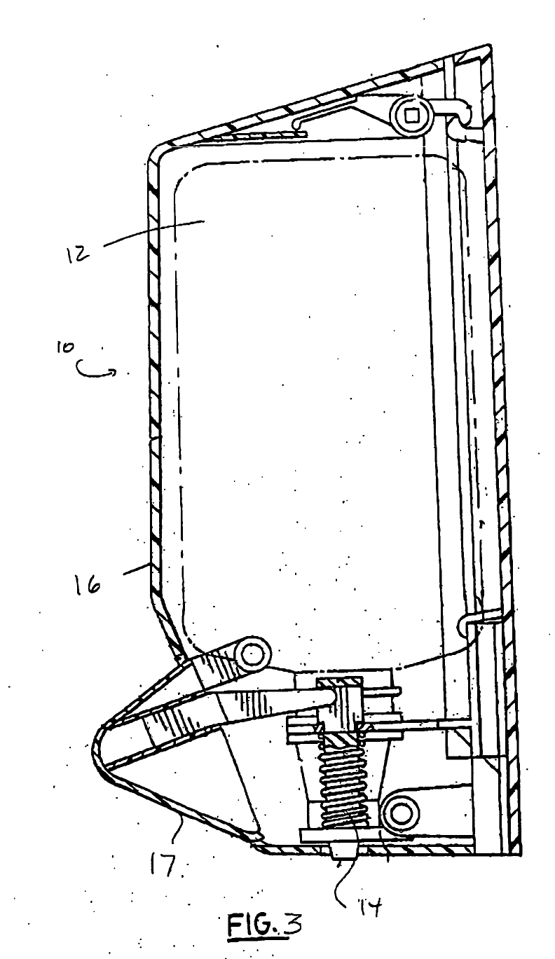

Referring to FIGS. 1 to 3, the dispenser for dispensing foam of the present invention is shown generally at 10. The dispenser has a rigid container 12, a pump 14 attached to the bottom thereof and a dispenser housing 16. The housing 16 has a lever 17 or other driving means which engages the pump 14.

The pump may be a number of dispensing pumps that are generally available. These pumps generally fall into two categories. These pumps were designed to be used in association with a collapsible dispenser and thus the pump or the container need be modified. Alternatively the pumps were designed to extend upwardly and thus need to be modified such that they are attached to the bottom of the container. Such pumps that could be used in the dispenser of the present invention are shown in U.S. Pat. Nos. 5,271,530 and 5,443,569 issued to Uehira et al. and U.S. Pat. Nos. 5,445,288 and 6,082,586 issued to Banks all of which are incorporated herein by reference in their entirety.

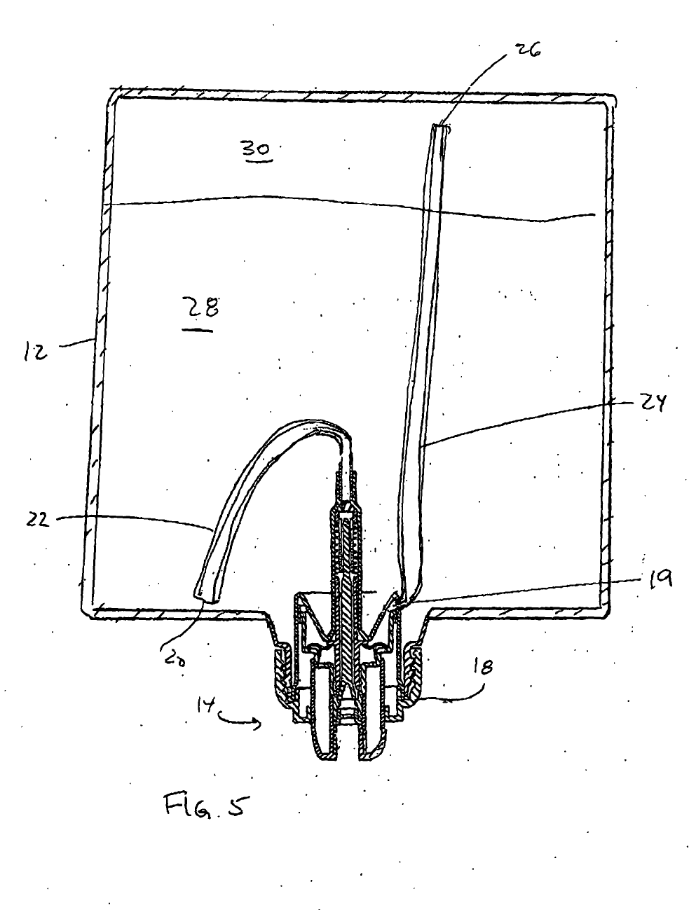

Referring to FIG. 5 inverted upright pump 18 (similar to that shown in the Uehira et al patents) has been modified such that the distal end 20 of Intake hose 22 extends into the bottom of the rigid container 14. A snorkel 24 extends from a vent hole 19 in the pump 18. The distal end 26 of snorkel 24 is at the top of the container. Such that the snorkel 24 extends through the soap 28 into an air pocket 30 at the top of the rigid container 12.

Alternatively as shown in FIG. 5 the vent hole 19 in Inverted upright pump 18 may be sealed and an aperture 32 may be formed in rigid container 12.

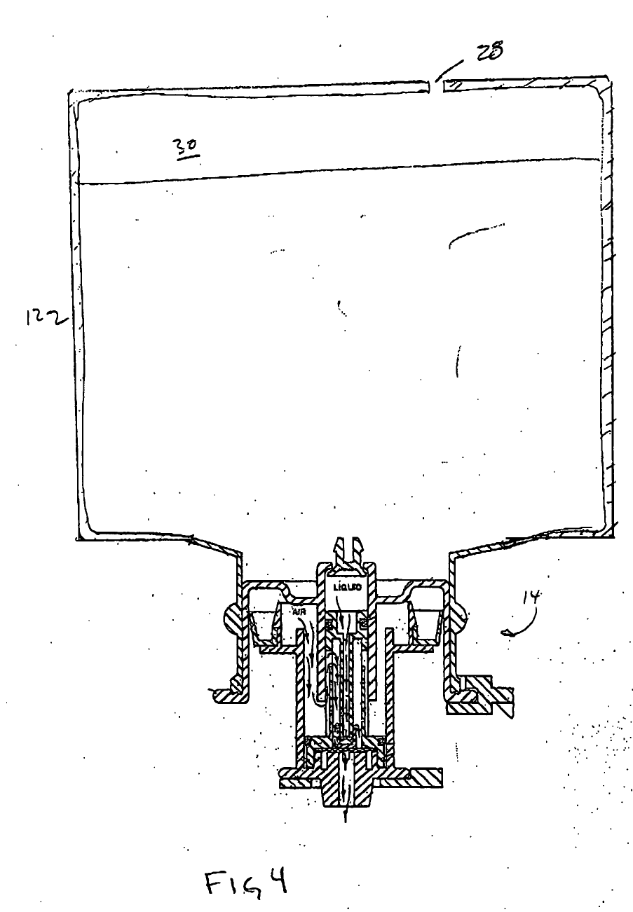

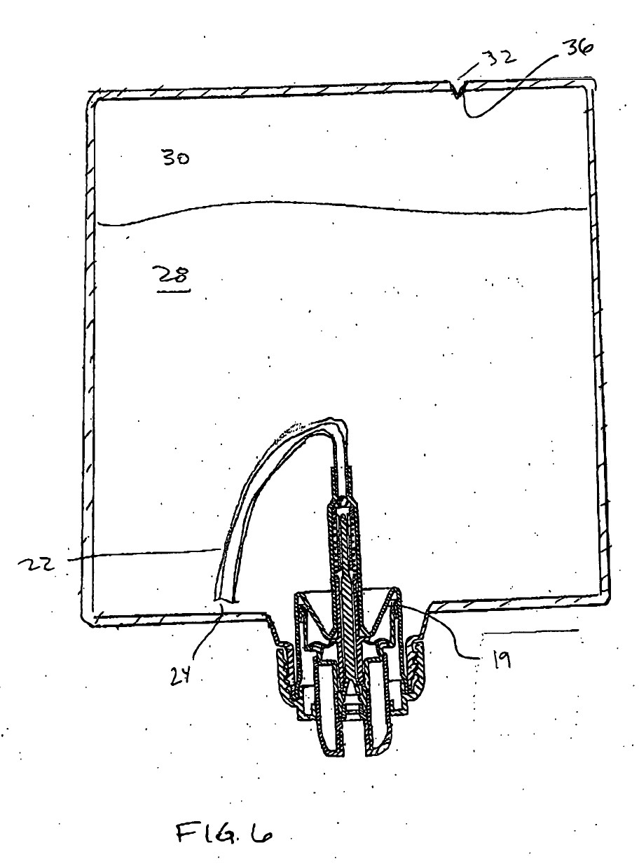

Telescoping pump 34 (similar to that in the Banks patents) as shown in FIG. 4 may also be adapted to be used in a rigid container. Rigid container 14 is provided with an aperture 28 to allow air Into the top of rigid container. A valve 36 may be Installed in aperture 28 or 32. An exampled of a valve is shown in FIG. 6.

In both of these examples the air pocket 30 inside the rigid container 12 is in direct communication with the atmosphere thereby allowing the pressure inside the container to equalize. This equalization of pressure serves to minimize and substantially prevent thermal and barometric ejaculation. In the embodiment shown in FIGS. 1 to 3 the pressure is equalized through the aperture 28. In the embodiment shown in FIGS. 4 and 5 the pressure is equalized through the snorkel.

As used herein, the terms “comprises” and “comprising” are to be construed as being Inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

1. A dispenser for dispensing foam comprising:
a rigid container having an interior wherein soap is received therein;
a pump attachable to the bottom of the rigid container adapted to mix the soap with air and produce a foam;
a means for venting air into the top of the rigid container, whereby the venting means is adapted to equalize the pressure in the interior of the rigid container; and
a housing wherein the rigid container, the pump and the venting means are insertable into the housing and a driving means in the housing operably engages the pump.

2. A dispenser as claimed in claim 1 wherein the driving means is a lever.

3. A dispenser as claimed in claim 2 wherein the pump is an inverted upright pump and the air venting means is a snorkel.

4. A dispenser as claimed in claim 2 wherein the pump is an inverted upright pump and the air venting means is an aperture formed in the top of the rigid container and wherein the upright pump has an air vent that is sealed.

5. A dispenser as claimed in claim 2 wherein the pump is a telescoping pump and the air venting means is an aperture formed in the top of the rigid container.

6. A dispenser as claimed in claim 4 wherein the aperture has a valve installed therein.

7. A dispenser as claimed in claim 5 wherein the aperture has a valve installed therein.

8. A dispenser as claimed in claim 1 wherein the air venting means is a snorkel extending from the pump to the top of the rigid container.

9. A dispenser as claimed in claim 1 wherein the air venting means is an aperture formed in the top of the rigid container.
